(19) United States
(12) Patent Application Publication
(10) Pub. No.: US 2025/0383025 A1
(43) Pub. Date: Dec. 18, 2025

(54) RETRIEVABLE CHECK VALVE

(71) Applicant: WRANGTECH DOO NOVI SAD, Novi Sad (RS)

(72) Inventor: Goran Andjusic, Novi Sad (RS)

(21) Appl. No.: 19/136,916

(22) PCT Filed: Dec. 8, 2023
(86) PCT No.: PCT/IB2023/062387

§ 371 Date: Jun. 9, 2025

(30) Foreign Application Priority Data
Dec. 9, 2022 (RS) P-2022/1128

(51) Int. Cl. F16K 15/04; E21B 34/06; E21B 34/08; F16K 27/02

(52) U.S. Cl. CPC F16K 15/04; E21B 34/063; E21B 34/08; F16K 27/0209; E21B 2200/04

(57) ABSTRACT

The invention is a valve intended for the production process of oil, gas, water or gas condensates, and primarily solves the problem of non-hermeticity of existing valves by introducing structural improvements.

The invention discloses two preferred embodiments, wherein the first preferred embodiment comprises a holder, a shear pin, an opened ball cage casing, an opened ball cage, a ball, a ball seat, two O-rings, a valve body, a mech-lock, a mech-lock holder, a rubber seal, a seating nipple. The second preferred embodiment comprises the elements from the first preferred embodiment, further comprising a slug catcher comprising a lower part of the slug catcher joint, an upper part of the slug catcher joint, a rubber seal, a slug catcher joint, a slug catcher pipe, a slug catcher top.

### TECHNICAL FIELD

The invention falls into the category of mechanical constructions, specifically valves. More precisely, the invention belongs to the group of valves designed for the oil, gas, water, or gas condensates production process.

### TECHNICAL PROBLEM

The invention addresses the technical issue of hermeticity loss that occurs in existing non-retrievable check valves due to their design drawbacks and the conditions in which these valves operate. This is crucial to fulfil their primary function—preventing the fluid backflow from the wellbore surface backward and through the pump (an integral piece of equipment for oil, water, gas, or gas condensate exploitation). Consequently, the invention resolves the problem of a shortened operational lifespan and compromised functionality of the non-retrievable check valves.

The invention also resolves the issue of fluid backflow from the tubing through the ESP, ESPCP, or LESP equipment due to the lack of hermeticity in the existing non-retrievable check valve. This is achieved by introducing enhanced design solutions for the retrievable check valve and its seating nipple and installing them into the tubing string in the oil, water, gas, or gas condensate exploitation process. In current practice, during the exploitation of oil, water, gas, or gas condensates, non-retrievable check valves have been traditionally employed. In the event of hermeticity loss, replacing these valves is not possible without pulling out the rest of the production equipment (pump, tubing, packer, etc.). This directly necessitates costly well workovers aimed at replacing the entire production equipment and incurs multi-day production losses.

The invention contributes to and affects the cost-effectiveness of the oil, water, gas, and gas condensate exploitation process, including the environmental impact of the mentioned production.

### BACKGROUND ART

During the installation of production equipment in wells producing oil, water, gas, or gas condensate, with a well reservoir pressure lower than the hydrostatic pressure in the wellbore column and insufficient well reservoir energy for achieving eruptive flow, it is necessary to apply one of the artificial lift exploitation methods to enable production.

These methods can vary; however, the equipment employed involving check valves as their integral part are the following: ESP (Electric Submersible Pump), ESPCP (Electric Submersible Progressive Cavity Pump), and LESP (Linear Electric Submersible Pump).

Equipment for the artificial lift methods for oil, water, gas, or gas condensates exploitation which is in a well essentially includes a pump with accompanying elements and tubing (pipes connected to the pump, i.e., pipes from which the pump is suspended; they extend to the surface opening of the well, through which oil, water, gas, or gas condensate is transported to the surface of the well).

The fundamental principle is that the fluid in the well moves from the bottom of the well, through the pump, the check valve, and the tubing, towards the surface of the well.

A common feature observed in the aforementioned existing artificial lift methods lies in the requirement for the exploitation equipment to incorporate check valves, in most cases. These valves play a crucial role in preventing the fluid backflow from the tubing (pipe) through the pump in the event of pump shutdown, whether it is planned, unplanned, or due to a malfunction. The technical operational principle of these valves centres on achieving and maintaining hermeticity. Such valves are installed during well workover into the tubing string (between two tubing joints). Importantly, these valves lack retrieval capability until the occurrence of another well workover, hence labelled as non-retrievable check valves.

In the case of hermeticity loss of the non-retrievable check valve in wells equipped with ESP and ESPCP, production can generally still be achieved, albeit at a reduced rate. However, in wells equipped with LESP, the pump completely loses its functionality.

To better understand the exploitation equipment in principle, please consult the following figures:
1) ESP equipment—The provided illustration (https://vibgyorpublishers.org/content/ijesg/fulltext.php?aid=ijesg-7-049) labels the non-retrievable check valve as “check valve” and positions it close to the Earth's surface, instead of immediately above the pump.
2) ESPCP equipment—The provided illustration (http://en.e-neng.net/index.php?route=product/product/index&product_sn=610) labels the non-retrievable check valve as “check valve” and positions it close to the Earth's surface, instead of immediately above the pump.
3) LESP—Reference to the video https://www.youtube.com/watch?v=UvBEso-Hr2s

Typically, a single non-retrievable check valve is installed, but there is an option to install two or more of them to enhance safety precautions. These non-retrievable check valves constitute an integral part of the equipment and are supplied along with the rest of the equipment, although there are rare cases where they are not installed at all.

The non-retrievable check valves require installation of the drain valves (labelled as “the drain valve” in the abovementioned illustrations 1 and 2 directly above the check valves, inside the tubing string. These drain valves may come with either a shear pin or a hydraulic disc. In the case of a drain valve with the shear pin, a rod is inserted into the tubing at the well's surface at the very beginning of the well workover to break the shear pin and enable the fluid backflow from the tubing string into the wellbore. This procedure is undertaken to release the fluid from the tubing string to enable the removal of the empty tubings, guarantee the safety of workers, and mitigate the risk of soil contamination. If the non-retrievable check valve lacks hermeticity, there is no need to open the drain valve, as all fluids will naturally discharge from the tubing during the pull-out from the well.

In the event of applying an artificial lift method to remove asphaltene, resin, and paraffin deposits from the inner walls of the tubing in a well equipped with a shear pin-type drain valve, there is a risk of detachment of the paraffin cutter's blade (from the wire). This can lead to the blade falling and breaking the shear pin, thereby opening the drain valve, and causing a complete cessation of production. In such cases, a replacement of the entire equipment, i.e. well workover becomes inevitable.

The existing non-retrievable check valves typically consist of the following elements: a ball cage casing, a ball cage, a ball, and a ball seat. More precisely, non-retrievable check valves are installed into a string of tubings (by being positioned between two tubing joints) above the pump at planned depths. These depths may vary based on factors such as the pump installation depth or the preferences of the production engineers employed by the oil company owning the well. The depths at which pumps are installed vary from a few hundred to several thousand meters. The assembly of the entire equipment in the well, including non-retrievable check valves, is conducted by a workover crew through the interconnection of threaded joints between two tubing sections.

There is another type of valve, as well—the retrievable check valves, which are employed for various tasks during well workovers (activating hydraulic packers, tubing string hermeticity check, etc). However, they are not employed in the production process. Similarly, to the non-retrievable check valve, the retrievable check valve must ensure hermeticity during operation, as this is its primary function.

Current solutions provide the option of using non-retrievable check valves in the exploitation process, which are installed as integral components during the installation of production equipment in the well. If hermeticity is compromised, non-retrievable check valves cannot be extracted until a well workover is conducted. This necessitates the removal of the entire equipment from the well, leading to a halt in well operations and subsequent economic losses until the entire equipment, including the tubings, the pump, etc, is pulled out.

The prevailing conditions inside the wells and the mechanical aspect of oil, gas, water, or gas condensate exploitation inherently reduce the lifespan of valves. This is primarily due to the wear and tear of valve components, ultimately undermining their essential technical function of providing hermeticity.

The pump shutdown in a well may occur either abruptly, due to a power outage, intermittently, due to a reduced fluid inflow from the well reservoir to the wellbore compared to the pump's capacity, or intentionally, due to the necessity for surface equipment maintenance, cleaning paraffin deposits from the tubing string, and similar procedures.

Damage to the check valve may go unnoticed during continuous pump operation, leading to hermeticity loss and subsequent fluid backflow from the tubing through the pump upon pump stoppage. Restarting the pump is unfeasible in this situation, as the pump shaft's back spinning during the fluid backflow could lead to shaft breakage, resulting in a complete pump failure. The occurrence of fluid backflow results in substantial production losses in oil, water, gas, or gas condensate. These losses result mainly due to the waiting period for the fluid backflow to complete. This completion phase ends the moment the fluid levels in the tubing and casing come to their equalizing reach point. This condition is necessary for the safe restart of the pump. Additionally, there is a subsequent delay in waiting for the pump to lift the fluid back to the surface and resume the production process. Additionally, throughout and following the completion of fluid backflow and the subsequent restart of the pump, there is increased heating of the electric motor and its accompanying components. This has a notably detrimental effect on the insulation of the motor windings, the insulation of the power cable, and rubber sealing elements. Moreover, it accelerates the rate of scale formation both inside and on the pump.

In certain cases, non-retrievable check valves losing hermeticity could result in temperatures (too) high for the electric motor of the pump. This triggers an automatic shutdown of the pump preventing the pump from effectively raise the fluid through the tubing up to the surface. This shutdown serves as one of the safety protocols aimed at preventing damage to the electric motor, which constitutes the most expensive part of the equipment. Efficient cooling of the electric motor requires a constant flow of “fresh” fluid from the well reservoir. As the fluid circulates over the electric motor housing, it absorbs heat, subsequently being sucked into the pump, and directed through the tubing string towards the surface.

In oil fields where reservoir pressure is significantly lower than the hydrostatic pressure in the wellbore column, indirect circulation of (treatment) fluid used for removing the mechanical impurities accumulated on the non-retrievable check valves is not feasible. These impurities may be a contributing factor to the valves losing their hermeticity.

Consequently, companies involved in oil, water, gas, or gas condensate production are compelled to either operate the pump in a modified/altered mode, awaiting equipment failure to initiate a well workover, i.e. replacing the entire underground production equipment or to promptly shut down the pump and conduct the well workover to prevent ongoing production losses and potential damage to the rest of the already technically functional equipment. Daily production losses caused by the fluid backflow persist, up to the point of the pump failure.

Illustration of an economic cost assessment:

The XX-1 well is equipped with an Electrical Submersible Pump (ESP). The well's production rate is 25 m³ of fluid per day, comprising 50% water cut and 12.5 m³ of (crude) oil. The pump operates in an intermittent mode due to its capacity of 50 m³ per day, operating at a motor frequency of 50.2 Hz. It runs for 30 minutes, followed by a 30-minute rest, and this cycle repeats throughout the day. The oil company opted for ESP equipment with a capacity exceeding the expected production rate of the well for several reasons, such as:
1. the anticipated production rate was initially higher; however, the reduction of the fluid inflow rate into the wellbore has prompted a switch in the pump's operation mode from continuous to intermittent.
2. considering hands-on experience, the scale deposits accumulate more rapidly due to the smaller technical openings on the pump stages (impellers and diffusers).
3. at that moment, the warehouse inventory did not contain a pump with the necessary capacity.
4. etc.

Furthermore, after a specific period (of well production), a loss of hermeticity in the check valve has occurred, resulting in issues related to fluid backflow during pump shutdown. Consequently, a modification in the pump's operational mode has been implemented, extending the running time to 160 minutes with a subsequent resting period of 120 minutes. This adjustment deviates from the prior cyclic pattern of 30 minutes of operation followed by a 30-minute rest. In effect, the pump has undergone 5 automatic shutdowns and restarts in total daily. Due to the fluid backflow (the non-hermeticity of the valve itself), the well is not operating at full capacity. This is because it requires 80 minutes to lift the fluid to the surface after each resting period. During this 80-minute period, as the pump operates and refills the tubing with no production at the surface of the well, the oil company incurs a loss of approximately 2.1 m³ of fluid. This comprises approximately 1.04 m³ of oil, considering a 50% water cut. At the average global crude oil price in 2022, which is 73,357 RSD/m³, this results in an approximate cost of 76,400 RSD per each altered operation cycle of ESP. There are 5 such downtimes (cycles) per day, resulting in a daily loss of approximately 390,000 RSD. The loss due to the fluid backflow, i.e., the altered operating mode would be 365 days×390,000 RSD=142,350,000 RSD on an annual basis. This calculation assumes that the electric motor and the hydro protector remain in a functional state, which is unlikely, as they are likely to experience failure due to operation in a high-temperature regime. In such a case, a well workover is necessary.

Additionally, there is an unreasonable electric power consumption during the operation of ESP equipment, during the process of filling the tubing with fluid until it is lifted to the surface. The pump section of ESP equipment, with a daily capacity of 50 m³, typically necessitates electric motors with power ratings between 28 and 45 kW.

The power consumption associated with filling the tubing after fluid backflow for one hour of operation is as follows:

$$28 kW - 403 RSD / hour ( average electricity price in kWh Serbia until August 2022 ) .$$

$$32 kW - 461 RSD / hour ( average electricity price in kWh in Serbia until August 2022 ) .$$

$$45 kW - 648 RSD / hour ( average electricity price in kWh in Serbia until August 2022 ) .$$

The ESP equipment featuring a 32-KW motor is installed in the XX-1 well, resulting in a daily cost of 2,305 RSD due to 5 (abovementioned) altered operation cycles throughout the day, each costing 461 RSD per hour (5×461 RSD/h=2,305 RSD/day).

On an annual basis, this amounts to 2,305 RSD×365 days=841,325 RSD.

Total loss on the XX-1 well annually is as follows:

Unproduced crude oil+consumed electric power=143,191,300.00 RSD, equivalent to €1,218,650.00 in RSD value.

The example should be understood as a rough representation of the economic loss due to the non-hermeticity of the existing non-retrievable check valves; by no means should it be considered a limiting parameter for the invention and its implementations.

Hence, both retrievable and non-retrievable check valves find application in the exploitation process, which includes activities like well workover and actual exploitation. Non-retrievable check valves have been specifically utilized in the process of active oil, water, gas, or gas condensate exploitation. Their primary challenge stems from the loss of hermeticity, primarily induced by the accumulation of mechanical impurities or mechanical damage to components like the ball, ball seat, or ball cage. In contrast, the retrievable check valve is employed for various other operations within the exploitation process.

The primary function of both types of valves is to prevent fluid backflow from the tubing string, which they achieve through their hermeticity. If they lose their hermeticity, they lose their fundamental function. Essentially, both types of valves are unidirectional, i.e., allowing the fluid to move from the well's bottom towards the well's surface.

Both types of valves are integrated into the tubing string, regardless of the process involved (well workover or exploitation).

The invention fundamentally improves the design of the structure of current retrievable check valves, enabling its application in the production (exploitation) process of oil, water, gas, or gas condensate, replacing the non-retrievable check valve.

Through its technical attribute of retrievability, the invention resolves the inherent limitation or issue associated with non-retrievable check valves, specifically the impracticability of their replacement without pulling out of the entire production equipment from the wellbore. The production equipment needs to be entirely pulled out of the well for replacement when the check valve loses its primary function, i.e., its hermeticity.

Additionally, beyond the mentioned benefits, the introduction of the retrievability feature in non-retrievable check valves for the oil, water, gas, or gas condensate production process has created the possibility of bullheading thermal treatments of the tubing and the pump. This involves directly pumping treatment fluids into the tubing string by retrieving the valve from the tubing string, which was not possible in the case of conventional non-retrievable check valves. This approach allows for a direct application of the treatment fluids for flow assurance, which is more efficient and cost-effective compared to the conventional and indirect thermal treatment methods. The purpose of these treatments is to remove the accumulated asphaltene, resin, and paraffin deposits. Following the same principle, it is possible to perform bullheading acid pump flush treatments on the interior of the tubing and pump to remove accumulated scale deposits without an increased risk of damaging the power cable clamped on the external side of the tubing string, located in the well casing. The efficiency of bullheading (direct) acid pump flush into the tubing string lies in the fact that the treatment fluid, whether hot water, oil, steam, or acid, directly reaches the intended locations, at the same time necessitating smaller quantities of those fluids used for flow assurance.
1—Indirect pumping involves pumping a treatment fluid from the wellhead into the wellbore casing, it then reaches the pump, passes through it, flows upwards through the non-retrievable check valve(s), traversing the entire tubing string, and emerges at the surface level of the well. Throughout this process, a portion of the treatment fluid is unwillingly pumped into the well reservoir, from which oil, water, gas, or gas condensate emerges into the wellbore.
2—Direct pumping involves pumping a treatment fluid from the wellhead directly into the tubing, which then passes through the entire tubing string, directly enters, and traverses the pump enters the wellbore, and flows upward towards the wellhead. A minimal, negligible amount of the treatment fluid may be pumped into the well reservoir from which oil, water, gas, or gas condensate emerges.

The occurrence of mechanical damage, leading to non-hermetic conditions in both valve types (retrievable and non-retrievable), is minimized through structural improvements introduced by this invention.

Disclosed technical improvement of the slug catcher 20 prevents the deposition of mechanical impurities on the valve, which otherwise accumulate and pose problems for existing non-retrievable check valve solutions by causing them to lose their hermeticity, respectively.

### SUMMARY OF THE INVENTION

The invention falls into the category of mechanical constructions, specifically valves used in the exploitation process (which includes workover, production, etc).

The invention fundamentally improves the structure of the existing retrievable check valve solutions, and, as such, becomes applicable in the actual production process of oil, water, gas, or gas condensate, instead of non-retrievable check valves.

The problems primarily addressed by the invention are:
1. The invention, through its technical property of retrievability, solves the fundamental drawback or problem of non-retrievable check valves, which is the inability to replace them without pulling out the entire production equipment from the well, which must be removed when the valve loses its basic function, i.e., hermeticity.
2. The occurrence of mechanical damage in both types of valves (retrievable and non-retrievable), leading to non-hermetic conditions, is minimized through the structural improvements introduced by this invention.
3. By implementing an enhanced structural design for the slug catcher 20, the accumulation of mechanical impurities (slug) on the valve is effectively mitigated. This preventive measure addresses the common challenge faced by the existing non-retrievable check valve solutions, where the deposition of impurities compromises their hermeticity. The incorporation of a new structural component, namely the lower end of the slug catcher joint 14, plays a pivotal role in achieving this improvement.

The invention goes beyond the outlined technical limitations of current solutions and addresses challenges such as equipment malfunction, production interruptions, financial losses due to production halts, and the need for well workover, to name a few. Through the improved design of the retrievable check valve and its integration into the production processes of oil, water, gas, or gas condensate—traditionally reliant on non-retrievable check valves—the invention tackles the abovementioned problems.

The application of the innovation, along with the specified structural enhancements, enables the removal and replacement of the check valve within the oil, water, gas, or gas condensate exploitation processes without requiring the pulling out of the remaining production equipment, such as the pump, the tubing string, the packer, etc. from the well. This stands in contrast to existing solutions, particularly non-retrievable check valves, where such removal without dismantling the entire production equipment is not possible.

Moreover, the need for utilization/installation is eliminated, along with the potential inclusion of a drain valve in the tubing string. This is achieved through the extraction of the retrievable check valve, ensuring efficient fluid backflow from the tubing string during the commencement of the well workover. The elimination of the drain valve from the production equipment setup minimizes the risk of unintentional shear pin breakage and drain valve opening caused by the fall of the tubing scraper for removing asphaltene, resin, and paraffin deposits, triggered by the wire breakage. Even if the scraper falls, it will come to a stop at the top of the retrievable check valve or its slug catcher, preventing any compromise in the hermetic integrity of the tubing string, and, consequently, eliminating the need for a well workover.

The invention discloses the following improvements over the conventional retrievable check valves:
the ball seat 6 is a pre-existing component utilized in sucker rod pumps. The construction design solutions of the invention's extensions incorporate the ball seat 6, optimizing both the ball 5 and the ball seat 6 (which functionally form a pair) to their technical maximum and the most economically justified state.

Achieving the technical maximum involves minimizing the risk of damage to the contact surfaces of the valve body 9 which is caused by direct positioning of the ball 5 onto it, as featured in the constructions without the ball seat 6, as detailed in the patent application form. This damage risk minimization ensures check valve's hermeticity, extended operational life, and proper functioning.

In solutions lacking the ball seat 6, damage occurs to the surfaces of the valve body with which the ball 5 makes contact due to its movement principle, necessitating the replacement of the entire valve body. This is essential as it becomes unusable, failing to fulfil its fundamental function of providing hermeticity with the ball 5 to prevent fluid backflow.

The existing solutions for retrievable check valves also grapple with the issue of relatively rapid deterioration of the inner surface of the element housing the ball (referred to as the opened ball cage 4 in this invention), a consequence of the ball's movement during pump operation, and the materials it is composed of. This deterioration eventually leads to the destruction of that element (the ball cage).

In certain instances, the ball cage may experience destruction and splitting due to the continuous radial movement of the ball 5. Despite the potential scenario where, upon pump shutdown, the ball remains in contact with its seat and continues to maintain hermeticity, the broken upper piece of the ball cage becomes detached in the process. The remaining lower piece of the ball cage remains secured on the top of the valve body, which is still affixed to its seating nipple (referred to as the seating nipple 13 in this invention). Consequently, the (conventional retrievable check) valve cannot be extracted from the tubing string in a routine, prompt, straightforward, and cost-effective manner. Specifically, the conventional methods for pulling out and replacement, as per the original design, become unfeasible without well workover, i.e., pulling it out from the well alongside the entire production equipment.

To elaborate, (apart from the axial movement) the ball 5 generally tends to radial movement as well, eventually causing damage to the inner wall of the ball cage 4. This damage is characterized by the formation of indentions on the inner wall of the ball cage 4, resulting in increased clearance for the radial movement of the ball 5, surpassing the initially designed limits of the radial movement. Consequently, the ball 5 deviates at varying angles from its intended axial movement, leading to contact with the surface of its seat, and causing the deformation of the contact surface of the ball seat, ultimately resulting in hermeticity loss.

The invention addresses the abovementioned technical problem by introducing the hard-lined ball guides of the opened ball cage 4.6, ensuring the ball seat's 6 integrity. The element prevents excessive radial movement of the ball 5, maintaining the designed limits and preventing hermeticity loss, accordingly.

Compared to the current technological state, the invention introduces an advancement by incorporating a dual-type sealing (rubber and metal) between the structural elements—the valve body 9 and the valve's seating nipple 13. This enhances the sealing property at the junction of these elements, ensuring its hermeticity. The rubber sealing is ensured by the rubber seals 12, while metal sealing is enabled by the conical surfaces of the valve body 9.7 and the conical surface of the valve seating nipple 13.4a. This mechanism ensures the hermeticity of the valve, with the metal seal coming into play in the event of 1) failure of the rubber seal caused by factors such as high temperature (rubber elements are prone to degradation or brittleness), 2) damage occurring during installation and other conditions throughout the uninterrupted operational period of the conventional retrievable check valve. In essence, the metal sealing will reinforce the hermeticity.

To achieve metal sealing (the contact between the conical surfaces 9.7 and 13.4a), requiring precise alignment of the valve body 9 with the valve seating nipple 13, a mechanical lock is introduced to secure the valve in its seating nipple 13.

The mechanical lock referred to in this application form relates to the mechanical and structural attachment of the elements, being the valve body 9, the mech-lock 10 and the mech-lock holder 11, which are functionally interconnected with the seating nipple 13 described in detail herein.

By implementing the outlined improvements, the invention ensures hermeticity in almost all operational scenarios.

Certain types of non-retrievable check valves may have the capability (though not always present) to be equipped with an element performing a slug catcher's function. Conversely, the present state of the art does not encompass retrievable check valves integrated with a slug catcher 19.

Those solutions exhibit a design flaw that does not completely resolve the issue of non-hermeticity. Specifically, upon the pump's shutdown, the fluid containing possible mechanical impurities (a natural occurrence during the exploitation of Earth's rock material) is halted at the slug catcher and in the free space between the slug catcher and the inner wall of the tubing where it is positioned with other valve elements. However, a portion of these impurities still permeates through to the valve's ball and its seat due to the shape design not providing an additional layer of protection. This results in contamination of the ball seat and the ball, ultimately leading to the loss of hermeticity.

The invention surpasses the problem of the current solutions to the slug catcher issues by introducing the improved construction design of the slug catcher 20, additionally preventing the mechanical deposit build-up, which would normally lead to the hermeticity loss of the valve (in general). These improvements involve:
the rubber seal 16, which serves as a functional and physical barrier between the deposits (formed under the above-described conditions) and all the valve elements.
the lower end of the slug catcher joint 14, which ensures the attachment of the retrievable check valve to the remaining elements of the slug catcher 20. Apart from the described connection function, the lower end of the slug catcher joint 14 additionally serves as a barrier preventing mechanical deposits from reaching the ball seat 6 and the ball 5.

Upon pump shutdown, the fluid inside the tubing string comes to a standstill (attributed to the hermetic characteristics of the retrievable check valve). The slug (comprising particles such as sediment, sand, corrosion residue, and others), settles on the initial barrier, identified as the rubber seal 16, due to the force of gravity. Should the invention be positioned at an angle within the wellbore, diverging from the vertical orientation if required by the second preferred embodiment of the invention, then a specific quantity of mechanical impurities could ingress into the slug catcher pipe 18 through the openings on the slug catcher pipe 18 (which serve as fluid exit ports during the pump's operation) if it were not from the lower end of the slug catcher joint 14. This prevents the slug from penetrating towards the ball 5 and its seat 6, averting the contamination of the valve. This, in turn, avoids the loss of hermeticity in the contact surface between the ball 5 and its seat 6, i.e. the entire retrievable check valve.

Two preferred embodiments of the invention have been disclosed in the application, being:
The first preferred embodiment of the invention includes the holder 1, the shear pin 2, the opened ball cage casing 3, the opened ball cage 4, the ball 5, the ball seat 6, the O-ring 7, the valve body 9, the mech-lock 10, the mech-lock holder 11, the rubber seal 12, the seating nipple 13, detailly described hereinafter.
The second preferred embodiment of the invention includes all the elements from the abovementioned first preferred embodiment of the invention and further includes the slug catcher 20 which includes the following elements: the lower end of the slug catcher joint 14, the upper end of the slug catcher 15, the rubber seal 16, the slug catcher joint 17, the slug catcher pipe 18, the slug catcher top 19, detailly described hereinafter.

### BRIEF DESCRIPTION OF THE DRAWINGS

The drawing includes figures of technical drawings of the presented, preferred embodiments of the invention as follows:

FIG. 1. portrays the holder 1 with the described elements.

FIG. 2. portrays the shear pin 2 with the described elements.

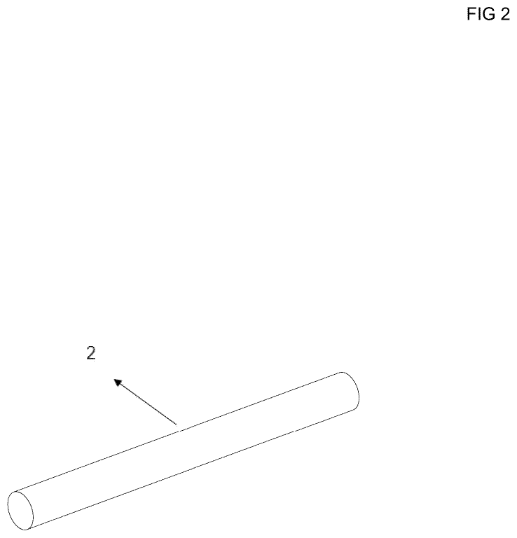

FIG. 3. portrays the opened ball cage casing 3 with the described elements.

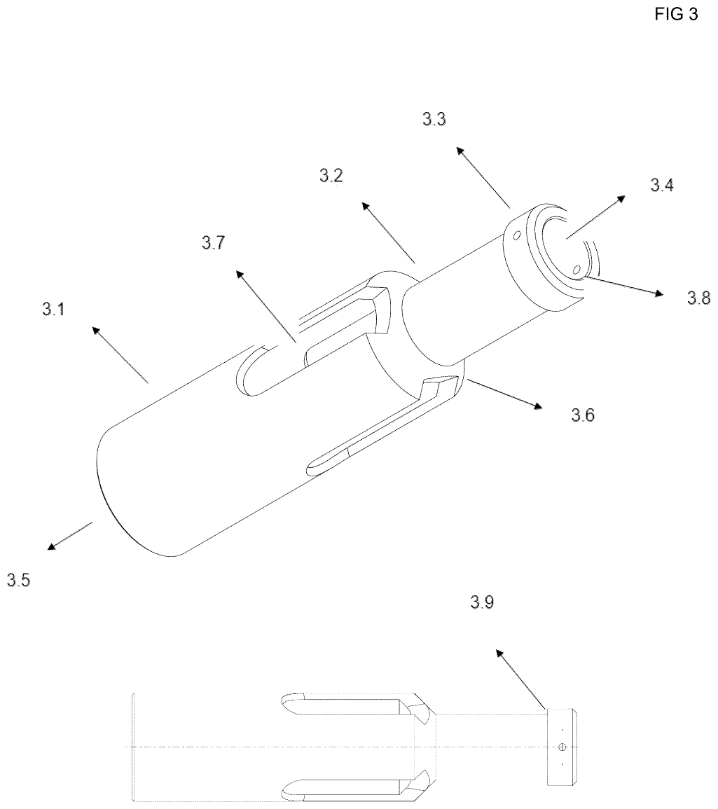

FIG. 4 portrays the opened ball cage 4 with the described elements.

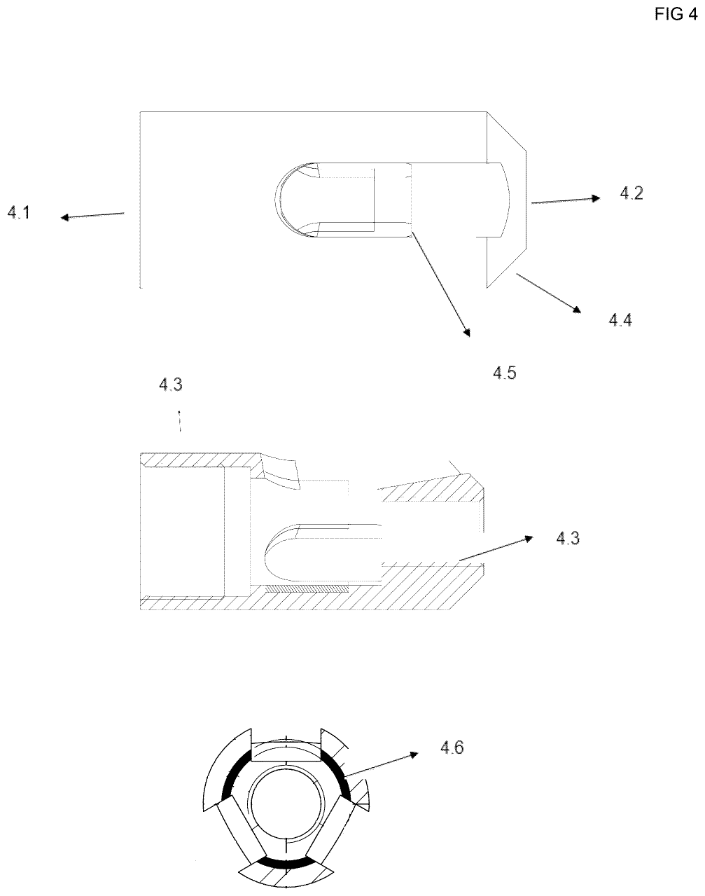

FIG. 5 portrays the ball 5.

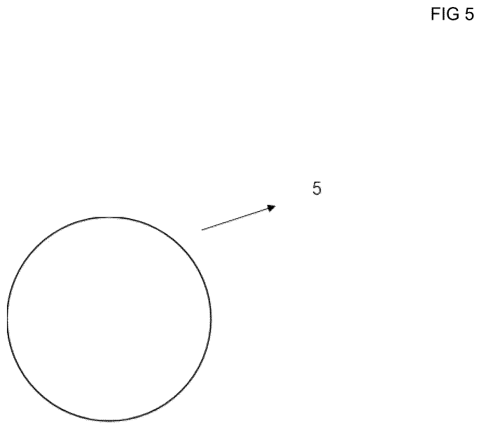

FIG. 6 portrays the ball seat 6 with the described elements.

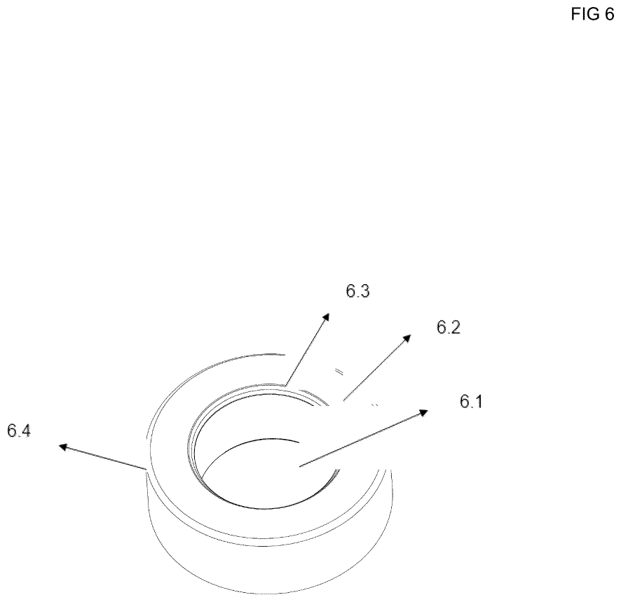

FIG. 7 portrays the O-ring 7.

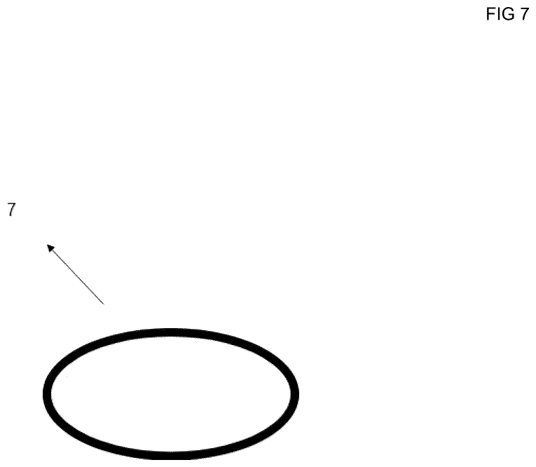

FIG. 8 portrays the valve body 9 in a lateral 3D projection 8 without individual quoting of the exposed elements, for better understanding.

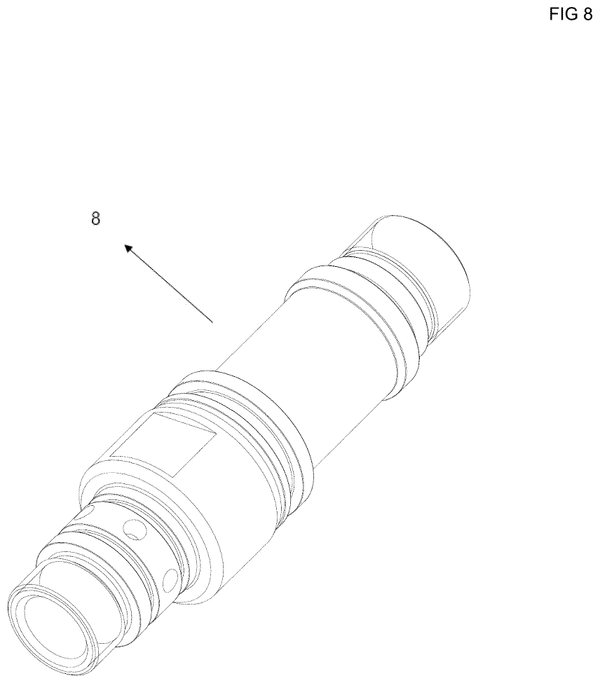

FIG. 9 portrays the valve body 9 with the described elements.

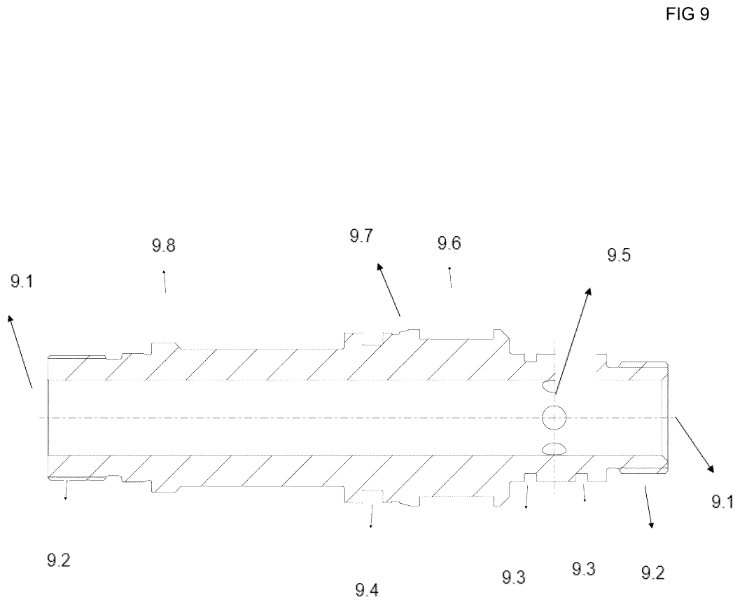

FIG. 10 portrays the mech-lock 10 with the described elements.

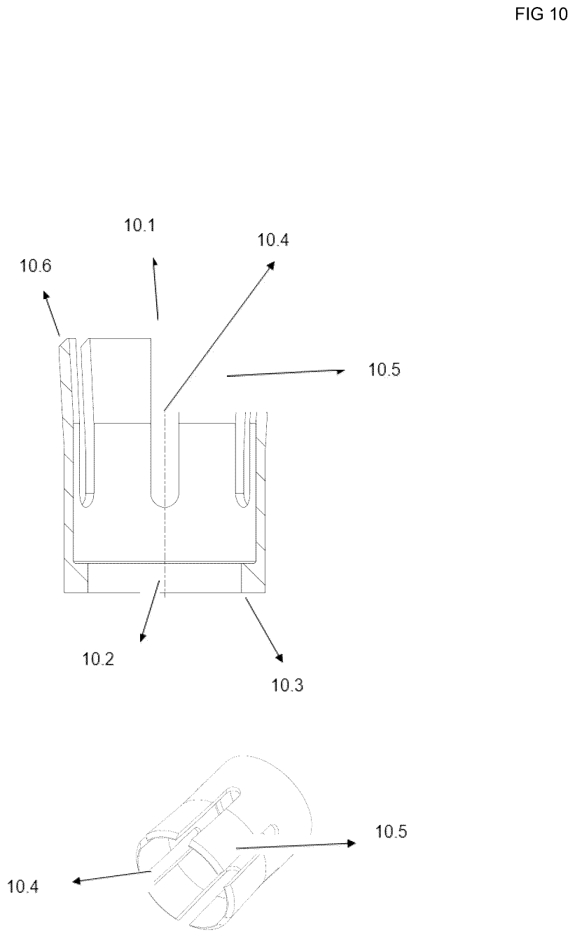

FIG. 11 portrays the mech-lock holder 11 with the described elements.

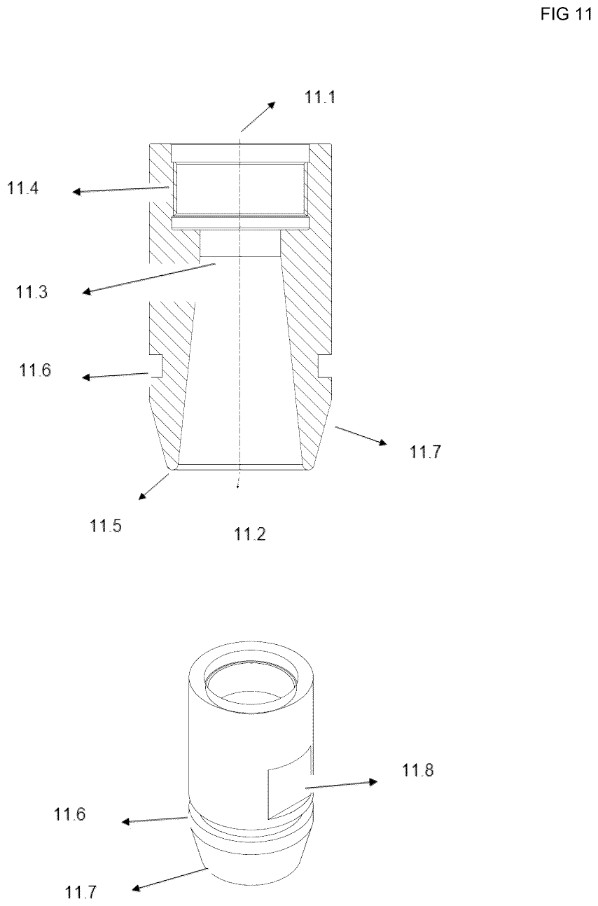

FIG. 12 portrays the rubber seal 12 with the described elements.

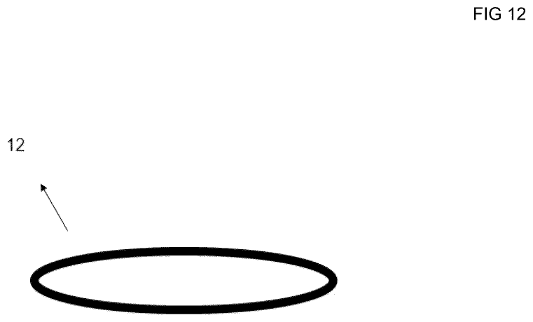

FIG. 13 portrays the seating nipple 13 with the described elements.

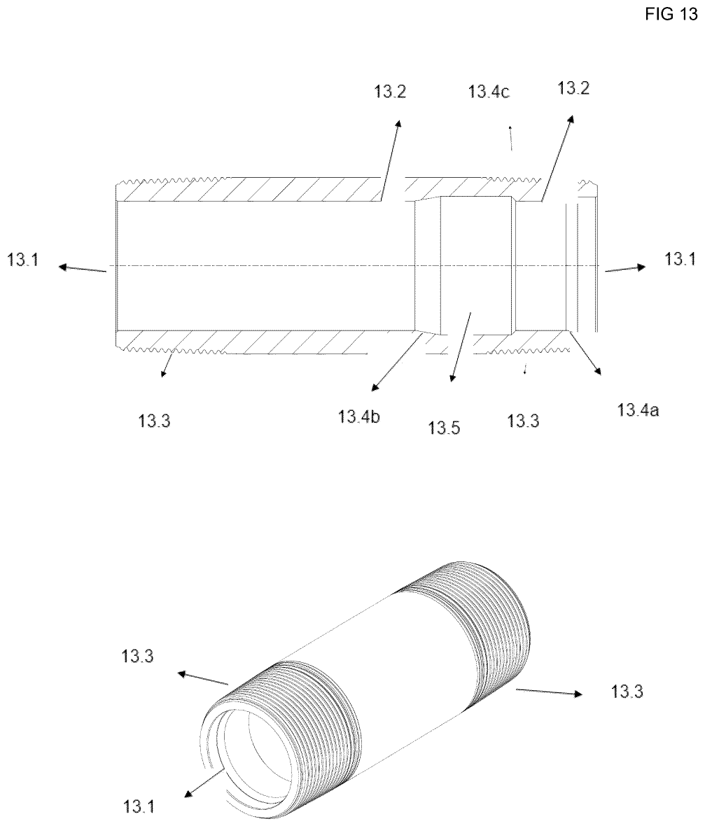

FIG. 14 portrays the lower end of the slug catcher joint 14 with the described elements.

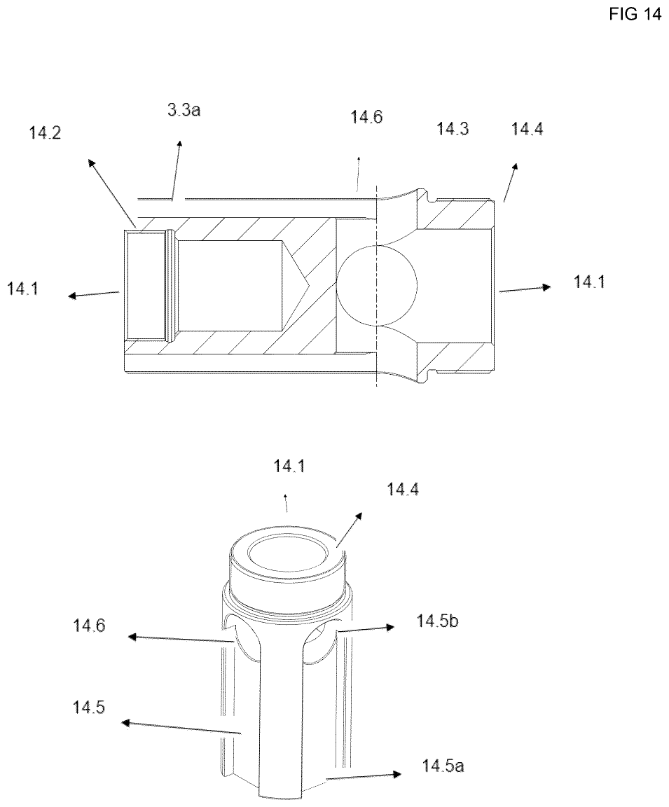

FIG. 15 portrays the upper end of the slug catcher joint 15 with the described elements.

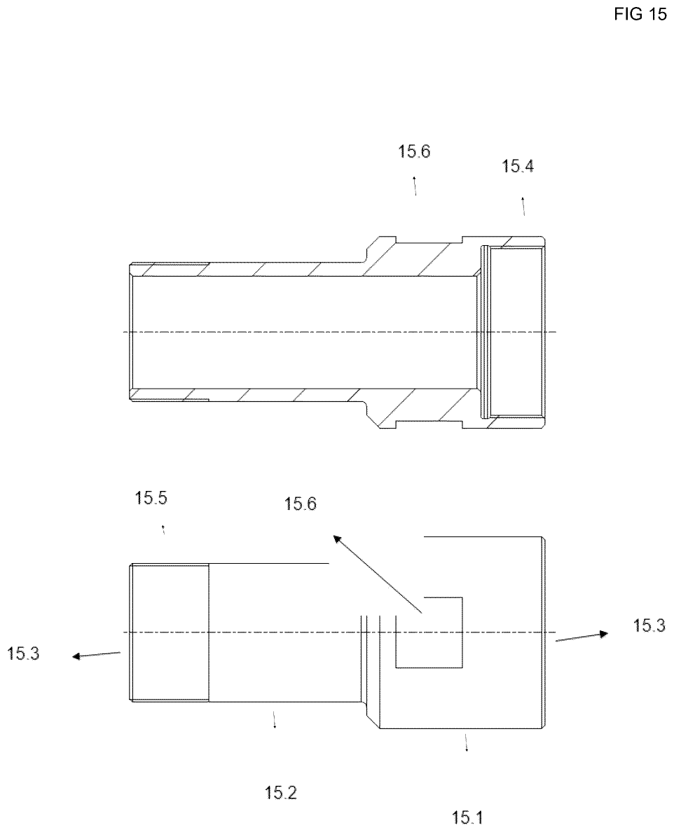

FIG. 16 portrays the slug catcher 20 with its described elements.

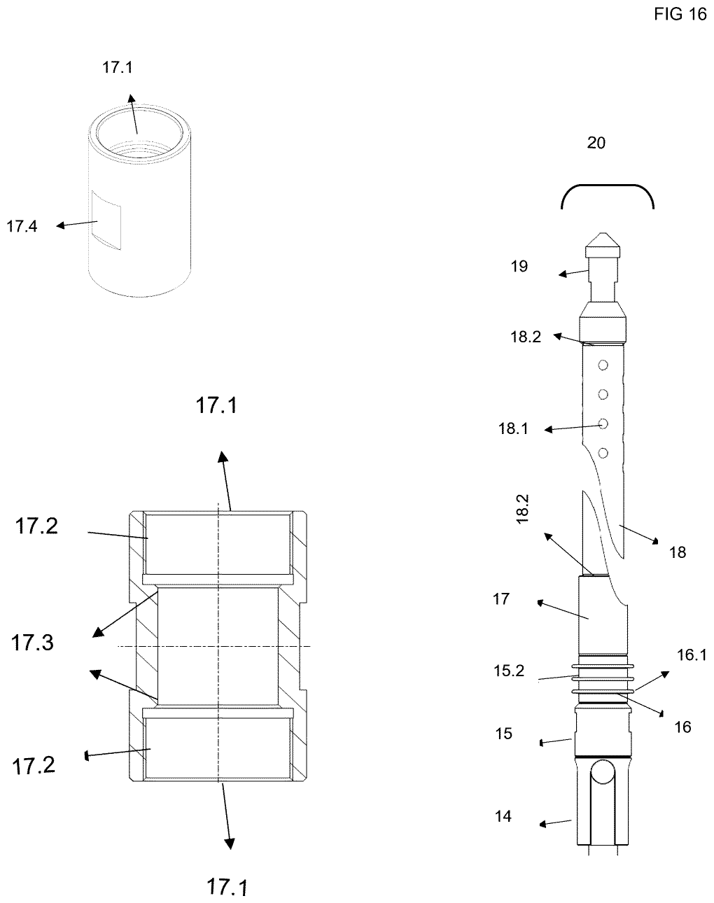

FIG. 17 portrays the slug catcher top 19.

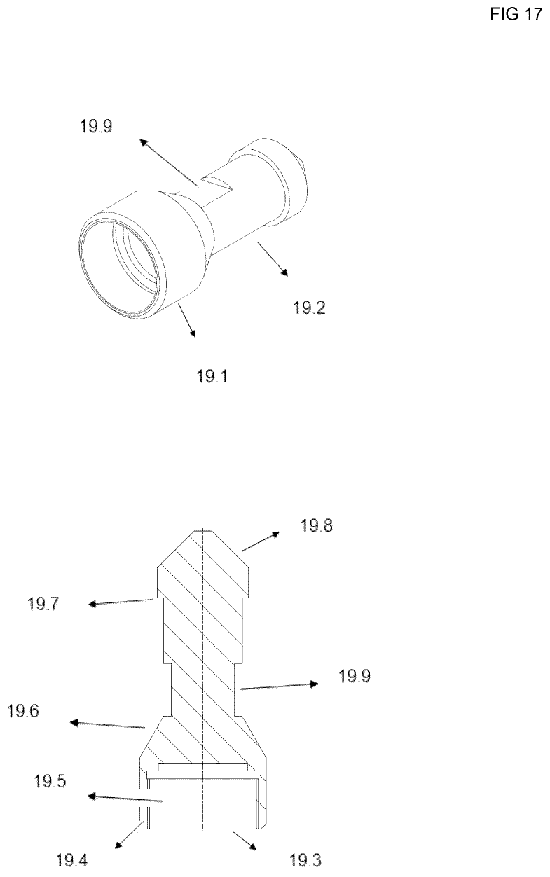

FIG. 18 portrays the check valve in two preferred embodiments with all the disclosed elements.

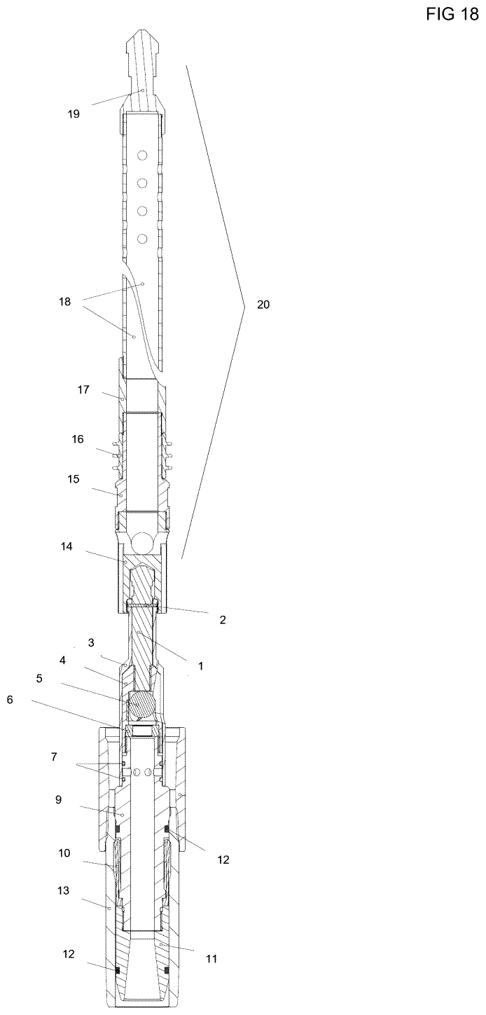

### DETAILED DESCRIPTION

The retrievable check valve (hereinafter referred to as “the invention”) is disclosed along with all its essential elements, which, in the described interrelation, form a distinct and unique inventive concept. The invention is not limited to the embodiments disclosed in the subsequent description in the text but is considered most preferable in those instances.

In any of the embodiments, the invention serves as a valve which is being installed as a part of the well's production equipment, specifically within a tubing string. This equipment is employed in the extraction of oil, gas, water, or gas condensates from both onshore and offshore wells, comprising multiple detachable structural components.

The invention, along with all its structural elements, can be constructed using various materials. It is preferable to utilize materials resistant to high temperatures, pressure, corrosion, fluid flow, and vibrations resulting from the fluid flow. Additionally, materials should withstand vibrations arising from the execution of the oil, water, gas, or gas condensate production process. This is to prevent the deformation of the invention during its application and ensure its intended functionality.

These materials include those comprising a metal base component, and metal alloys, and are not limited to materials possessing the aforementioned properties, such as carbon fibres or high-resistance plastics, like ABS (acrylonitrile butadiene styrene), polycarbonate, high-density polyethylene, polyamide-imide, polydicyclopentadiene (PDCPD), and similar.

The invention does not exclude the possibility of combining different materials for the construction of the described elements in any embodiment.

The terms used in this application have the following meanings:
“Offshore wells” refer to wells for the production of oil, gas, water, or gas condensates located on water surfaces (e.g., seas).
“Onshore wells” refer to wells for the production of oil, gas, water, or gas condensates drilled on land.
Remark: The valve body component is herein labelled by the numeral 9. Simultaneously, the numeral label 8 pertains to the three-dimensional figure of the valve body 9 for enhanced understanding and is excluded in subsequent references within the application text.

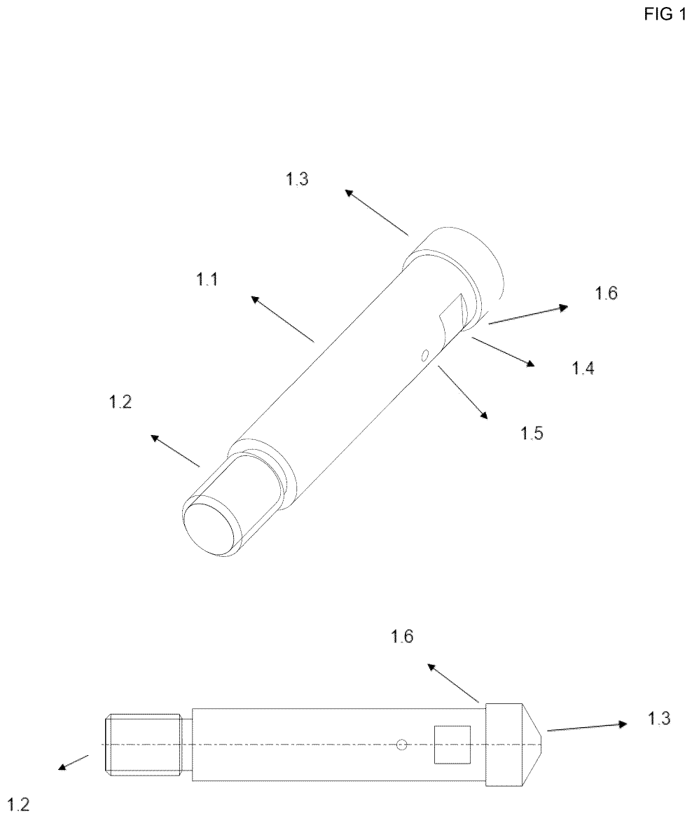

In the first preferred embodiment, the invention encompasses the following elements:
The holder 1, a cylindrical-shaped element, is designed to comprise at least: the holder body 1.1, the holder base with threads 1.2, and the holder top 1.3. The holder body 1.1 has two opposing ends, with one end connected to one end of the holder base 1.2, and the other end of the holder body connected to one end of the holder top for a unified structure.
The holder body 1.1. preferably includes a fastening element 1.4 and at least one opening for the shear pin 1.5, where both elements are extended from beneath the holder top 1.3, wherein the arrangement of elements shown in FIG. 1 is a preferred variation but does not preclude a different arrangement. The fastening element 1.4 is designed as a depression (groove), allowing the tool used to secure the holder to the opened ball cage 4 to hook onto it and, by rotating, tighten the structure. The shear pin opening 1.5 is designed to allow the shear pin 2 to be fully inserted into the holder body 1.1.
The holder base 1.2 has two ends and is comprised of a thread section, it is connected at one end to one end of the holder body 1.1, whereas the other end leads through the opening of the opened ball cage casing 3.4 to the opening of the opened ball cage 4.3, which is connected through the extended thread section by screwing.
The holder top 1.3 has two ends, it is connected at one end to one end of the holder body 1.1, whereas the other end of the holder top 1.3 has a conically tapered construction to form a truncated cone. The diameter of the holder top 1.3 at its base is wider than the diameter of the holder body 1.1, so that it forms a (flattened) extension 1.6 at the junction with the holder body 1.1, which restricts the movement of the opened ball cage casing 3 vertically upward during the pull out of the invention from the well, and potentially allows the attachment of the tools in the event of a well failure for pulling out the invention from the tubing string of the well.
The holder 1 can have a solid interior.
The thread section at the holder base 1.2 can be made by cutting or rolling procedure.
The diameter of the holder base 1.2 can be narrower or equal to the diameter of the holder body 1.1.
The holder 1 can be made from a single piece or multiple assembly parts, as described, and in that case, the joining method can involve welding.
The shear pin 2, is a cylindrical-shaped element with a diameter smaller than the diameter of the shear pin opening 1.5 into which it is inserted. The shear pin 2 can have flattened ends, and it is preferably made of solid material.
The opened ball cage casing 3, a cylindrical-shaped element, is constructed to have varying diameters throughout the entire casing structure, forming both narrower and wider sections. The opened ball cage casing 3 has two opposite ends and entails the following elements:
the opened ball cage casing body 3.1, the neck of the opened ball cage casing 3.2, the ring-shaped element 3.3, comprising one opening at each end of the construction, but with one opening having a smaller diameter 3.4 (hereafter: the narrower opening) compared to the diameter of the second opening 3.5 (hereafter: the broader opening).
The opened ball cage casing body 3.1 is constructed to have two opposite ends, a hollow interior, with one end featuring a broader opening 3.5, while the other end tapers conically and forms a conical shape with a flattened portion 3.6, i.e., the point where the opened ball cage casing body 3.1 connects to the opened ball cage casing neck 3.2. The opened ball cage casing body features three fluid passage openings 3.7, constructed so that they are preferably extended from half the length of the opened ball cage casing body 3.1, and extend to the extreme edge of the opened ball cage casing body part where the tapered narrowing 3.6 begins.
In this embodiment, three fluid passage openings 3.7 are illustrated; however, it remains feasible to encounter either a single such opening or more than three openings in alternative embodiments of the invention. The dimensions of these openings may be adjusted accordingly to fulfil their intended function.
The openings for fluid passage 3.7 enable the fluid, coming from the broader opening 3.5 and progressing towards the narrower opening 3.4, to exit sideways away from the opened ball cage casing body 3.1 when the ball attains its active state (shifted axially upward). This occurs due to the fluid's motion driven by the pump's operation, pushing the fluid towards the wellbore surface.
The openings for fluid passage 3.7 must have a smaller diameter than the ball 5 to avoid the ball 5 being ejected or dislodged from the valve due to the pressure and fluid flow generated by the pump's operation in the well.
The diameter of the opened ball cage casing body 3.1 must have bigger diameter than the opened ball cage 4 to enable the opened ball cage 4 to enter the opened ball cage casing body 3.1.
The opened ball cage casing neck 3.2 has two opposite ends, having one of its ends attached to the opened ball cage casing body 3.1, and the other one attached to the ring-shaped element 3.3.
The ring-shaped element 3.3 which is attached to the opened ball cage casing neck 3.2 in the above-described manner is bigger in diameter than the opened ball cage casing neck 3.2, and it forms a flattened extension 3.9 used for attaching the tool used for installing and pulling out the retrievable check valve from its seating nipple 13, i.e., from the tubing string of the well. The ring-shaped element 3.3. is further constructed so that the single opening 3.8 extends from the ring-shaped element 3.3 and through that opening 3.8 the shear pin 2 is being introduced to the shear pin opening 1.5.
The opened ball cage casing 3 can be made from a single piece or multiple assembled parts, as described, and in that case, the method of connection can involve welding.
The opened ball cage 4, a cylindrical-shaped element, with two opposite ends with openings introduced at both its ends, with its one end having a smaller diameter opening 4.2 (hereafter: the narrower opening) compared to the diameter of its second opening 4.1 (hereafter: the broader opening). The opened ball cage contains a hollow interior and forms a pipe-like structure. The opened ball cage 4 is further constructed to contain two thread sections 4.3, one thread section 4.3 being threaded on the interior side of the broader opening 4.1, and the other thread section 4.3 threaded on the interior part of the narrower opening 4.2. The thread section at the broader opening 4.1 is designed for the connection of the opened ball cage 4 to the valve body 9.
The opened ball cage has a conical taper 4.4 at its narrower opening 4.2 to form a truncated cone shape. The cage of the ball 4 further includes at least three fluid passage openings 4.5, which are made on the lateral sides of the construction of the opened ball cage 4 and at least three hard-lined guides 4.6. Each fluid passage opening 4.5 is constructed so that it preferably extends approximately from half the length of the opened ball cage construction 4 and further extended to the conical taper 4.4.
In this configuration, three fluid passage openings 4.5 are illustrated. Nevertheless, it remains feasible for alternative embodiments of the invention to include either a single opening or multiple openings exceeding three. The dimensions of these openings may be adjusted based on their quantity to achieve their designated purpose.
The hard-lined guides 4.6 are situated on the inner surface of the opened ball cage 4, aligning with the adjacent fluid passage openings 4.5 and matching their quantity. These hard-lined guides 4.6 are hard-lined with a material that is necessarily harder than the material constituting the opened ball cage 4 itself, but softer than the material used for the ball 5. This design ensures that the hard-lined guide 4.6 prevents the ball 5 from causing damage to the inner side of the opened ball cage 4 during its movement within the cage while the pump is in operation.
The ball cage 4, with its conically narrowed part 4.4 and its narrower opening 4.2, is inserted into the opened ball cage casing 3 through the wider opening 3.5 of the opened ball cage casing and, in its entirety, is positioned within the opened ball cage casing body 3.1.
By introducing the opened ball cage 4 into the opened ball cage casing 3 as described above, the fluid passage openings 4.5 of the opened ball cage and the fluid passage openings 3.7 of the opened ball cage casing 3 are brought into an opposite and parallel position, allowing the fluid flow as described above. Fluid passage openings 4.5 and fluid passage openings 3.7 do not come into contact with each other's surfaces, allowing for an unobstructed passage between them.
The ball 5, a geometrically spherical-shaped element, preferably crafted from solid material, featuring a diameter greater than the diameter of the fluid passage opening 4.5 of the opened ball cage 4 and the fluid passage opening 3.7 of the opened ball cage casing 3, thereby preventing the displacement of the ball 5 during its motion inside of the opened ball cage 4.
The ball transitions into its active state, moving axially, as a result of the upward flow of the fluid along the longer axis of the invention from the wellbore bottom to the Earth's surface. It assumes a passive state when the pump, responsible for lifting fluid from the wellbore to the Earth's surface, stops operating. In the state of rest, the ball makes contact with the upper edge of the opening 6.3 of the ball seat, ensuring a seal between the ball seat 6 and the ball 5. Upon pump shutdown, the ball 5 creates contacts with its seat 6, rests against the inner edge of the opening 6.3, and ensures hermeticity.
The ball seat 6, a cylindrical-shaped element, constructed to include: the extended opening 6.1 positioned at the structure's centre, along with the flat surfaces 6.2 on the upper and lower parts of the ball seat, inner edge of the opening 6.3, and outer edge of the opening 6.4, featuring an opening 6.1 of smaller diameter compared to the ball diameter 5, while the flat surfaces 6.2 on the upper and lower portions of the ball seat 6 are entirely flat and parallel to each other.
The inner edge of the opening 6.3 is chamfered towards the interior of the ball seat 6 structure, creating an angled surface. This configuration allows a precise alignment between the ball 5 and the opening 6.1 during the ball's 5 inactive state. This results in contact with the inner edge of the opening 6.3, effectively sealing the opening 6.1 and ensuring hermeticity.
In addition to the materials specified in the description, the ball seat 6 has the potential to be crafted from ceramic too, where the hardness level of the ball seat 6 must be kept lower than that of the ball 5. This precaution is taken to maintain the physical characteristics of the ball 5; failure to do so would jeopardize the hermeticity between the ball 5 and the seat 6, and thus the integrity of the entire valve.
The O-ring 7, a ring-shaped element which engages with the groove 9.3 on the check valve body 9. This configuration shows two O-rings 7. The invention can include a single rubber seal or more than two rubber seals, with the quantity of rubber seals corresponding to the number of grooves 9.3 where they are inserted.
The valve body 9, a cylindrical element with two opposing ends, hollow throughout its entire structure, and incorporating the following features: extended openings at both ends 9.1, two threaded sections 9.2 on the external surface of the structure; two dents designed to form a groove 9.3 (hereafter: groove), each groove 9.3 accommodating an O-ring 7, a depression constructed to form a groove 9.4 into which a rubber seal 12 is inserted, a fluid backflow opening 9.5 extended on the surface between two grooves 9.3, and a fastening element 9.6 extended as a depression (groove) and can have a rectangular or squared shape. This enables the valve body 9 to connect and secure with other components of the valve structure by turning it using the appropriate tool, conically chamfered edges 9.7 toward the inner side of the structure, ensuring metal-to-metal sealing (metal sealing). The valve body 9 then features a conical extension 9.8, serving as a mech-lock 10 limiter as well.
The invention includes at least one fluid backflow opening 9.5, with the depicted embodiment featuring six such openings 9.5.
In the presented embodiment of the invention, the described components are preferably arranged as follows:
the opening 9.1, the thread section 9.2, the groove 9.3, six fluid backflow openings 9.5, the groove 9.3, the fastening element 9.6, the conically chamfered edges for metal sealing 9.7, the groove 9.4, between which is a construction element, the conical extension 9.8, the thread section 9.2 ending the lower end of the valve body 9, where another opening 9.1 is formed.
The mech-lock 10, a cylindrical element, with two opposite ends, with a hollow interior in its entire construction, includes the following elements: two extended openings, one bigger diameter opening 10.1 (hereinafter: the wider opening) compared to the diameter of the second opening 10.2 (hereinafter: the narrower opening), the flattened surface 10.3 located near the narrower opening 10.2, the semi-openings 10.4, and between two adjacent semi-openings 10.4, the surface 10.5 is formed. The mech-lock 10 also includes the conically chamfered edges 10.6.
The lower end of the mech-lock 10, near the opening 10.2, is inserted into the seating nipple 13 through the opening 13.1. In contact with the conical surface 13.4a, the contact surface 10.5 narrows relative to its initial uncompressed position, allowing it to pass through the constriction 13.2. Subsequently, it is guided into and positioned within the mech-lock compartment 13.5. The conically chamfered edges 10.6 make contact with the conical surface 13.4c, effectively securing the retrievable check valve in its seating nipple 13.
The degree of curvature of the surface 10.5 may vary, and a preferred curvature is 3 degrees.
The mech-lock is constructed to ensure that the valve, throughout its operation, remains securely in its designated position within the seating nipple 13, preserving its hermeticity.
The mech-lock holder 11, a cylindrical-shaped element, possessing two opposing ends within its entirely hollow structure and encompasses the following features: two extended openings, where one, identified as 11.1, has a bigger diameter (hereafter: the wider opening) compared to the second opening 11.2 (hereafter: the narrower opening). Additionally, it incorporates a conical taper 11.3 on the inner side, forming a funnel-like structure, the internally threaded section 11.4 beneath the wider opening 11.1, the rounded edges 11.5 adjacent to the narrower opening 11.2, the circular depression forming the groove 11.6 designed for housing the rubber seal 12, the externally conical taper 11.7, and a fastening element 11.8.
The groove 11.6 serves the purpose of accommodating the rubber seal 12, while the fastening element 11.8 facilitates the attachment of the tool used for attaching the mech-lock holder 11 to the valve body 9. This connection can be secured by locking and tightening the construction through rotation and can have a rectangular or squared shape.
The rubber seal 12, a ring-shaped element, placed inside the groove 11.6 of the mech-lock holder 11 and inside the valve body groove 9.4. The invention comprises a minimum of two seals, identified as 12.
The seating nipple 13, a cylindrical-shaped element, possesses its two opposing ends, characterized by a completely hollow internal structure, and comprising the following elements:
two extended openings 13.1, at its both opposing ends, along with two tapered sections within the internal structure 13.2, two thread sections 13.3 present on the exterior side of the structure, featuring one thread section 13.3 positioned beneath each opening 13.1 at the opposing ends of the seating nipple 13, the conical surfaces 13.4a, 13.4b, and 13.4c incorporated on the internal side of the structure, and the mech-lock compartment 13.5.
The conical surfaces 13.4a and 13.4b play a facilitating role in the insertion of the mech-lock 10, the mech-lock holder 11, and the rubber seals 12 into the seating nipple 13. Meanwhile, conical surface 13.4a establishes a metal seal with the conically chamfered edges for metal sealing 9.7 on the valve body 9 when the valve assumes its final position. The conical surface 13.4c, featuring the conically chamfered edges 10.6 of the mech-lock 10, establishes contact and securely holds the retrievable check valve within its seating nipple 13.
The seating nipple 13 is connected at both ends through thread section 13.3 to tubing joint elements (joints) within the wellbore, not constituting part of the invention. This allows the presented embodiment of the invention to be securely affixed within the tubing string. The connection is achieved by screwing the seating nipple 13 into the tubing joint elements (joints).

In the second preferred embodiment, the invention retains components from the first preferred embodiment design, respecting both the structure and the details outlined in the first preferred embodiment. However, elements that differ from the first preferred embodiment in the second preferred embodiment are acknowledged as such. Additionally, the second preferred embodiment introduces additional elements, as well, and it includes the following:

The second preferred embodiment of the innovation incorporates: the holder 1 in accordance with the description provided in the first preferred embodiment, the shear pin 2 in accordance with the description provided in the first preferred embodiment, the opened ball cage casing 3 in accordance with the description provided in the first preferred embodiment, with a modification that features a thread section 3.3a on the external side of the construction instead of the ring-shaped element 3.3; the opened ball cage 4 in accordance with the description provided in the first preferred embodiment, the ball 5 in accordance with the description provided in the first preferred embodiment, the seating nipple 6 in accordance with the description provided in the first preferred embodiment, two O-rings 7 in accordance with the description provided in the first preferred embodiment, the valve body 9 in accordance with the description provided in the first preferred embodiment, the mech-lock 10 in accordance with the description provided in the first preferred embodiment, the mech-lock holder 11 in accordance with the description provided in the first preferred embodiment, two rubber seals 12 in accordance with the description provided in the first preferred embodiment, the seating nipple 13 in accordance with the description provided in the first preferred embodiment; the innovation in accordance with this embodiment introduces a slug catcher 20 featuring the following elements:
The lower end of the slug catcher joint 14, a cylindrical-shaped element with its two opposing ends, incorporating: one opening 14.1 extended on each of its opposing ends, the thread section 14.2 on the internal surface of the construction, the thread section 14.3 on the external surface of the construction, the flattened surface 14.4, the groove 14.5 situated on the lateral side of the construction, and the fluid passage opening 14.6.
The lower section of the joint 14 is connected via the thread section 14.2 onto the opened ball cage casing 3 using the thread section 3.3a, facilitating the insertion of holder 1 into the lower end of the joint 14. The lower end of the slug catcher joint 14 is connected to the upper end of the slug catcher joint 15 via thread section 14.3.
The groove 14.5 is extended towards the internal side of the construction and exhibits its two ends. One end 14.5a forms a rectangular shape that transitions into the other end, adopting a rounded semi-circular shape 14.5b, forming the fluid passage opening 14.6 at the rounded position, directed towards the centre of the structure.
The lower end of the slug catcher joint 14, features a hollow interior on the internal thread section 14.2 enclosed in its construction, and structurally conforming to the design of the upper part of holder 1.3, which is inserted into the lower end of the slug catcher joint 14.
This configuration of the invention involves four grooves 14.5 and four fluid passage openings 14.6.
The upper end of the slug catcher joint 15, a cylindrical-shaped structural element characterized by varying diameters across its entire composition, thereby delineating its broader 15.1 and narrower 15.2 segments, encompassing the following features: the extended one opening per both its opposing ends 15.3, the tread section 15.4, the thread section 15.5 on the internal side of the structure, the tread section 15.5 on the external side of the structure, and a fastening mechanism manifested as a groove 15.6 on the broader end 15.1.
The fastening element 15.6 may adopt a rectangular or squared shape, facilitating the secure connection of the upper end of the slug catcher joint 15 to the lower end of the slug catcher joint 14 using the appropriate tool.
The rubber seal 16, the ring-shaped element designed to be positioned on the external side of the upper end of the slug catcher joint at its narrower part 15.2, where the external surface edge of the rubber seal 16.1 component forms contact with the inner side of the tubing string into which the valve itself is installed. During pump shutdown, when the fluid in the tubing is in a state of rest (due to the valve's hermeticity), under the influence of gravitational force the slug, a constituent part of the fluid (sediment, sand, corrosion particles, etc.) forms deposits on the first barrier, in this case-the rubber sealing 16, and remains there. The rubber seal 16 serves as a functional barrier between the slug under described conditions and all the valve elements. The invention includes at least one rubber seal 16, while in the depicted embodiment, the invention encompasses three rubber seal 16.
The slug catcher joint 17, a cylindrical-shaped element with hollow interior, having its two opposing ends, comprises the following: one opening per both its opposing ends 17.1, two internal thread sections 17.2, the fastening element 17.4 extended in a form of a groove on the central external side of the element, and a cylindrical taper of the internal part of the construction 17.3. One thread section 17.2 connects the slug catcher joint to the upper end of the slug catcher joint 15 by screwing it onto the thread section 15.5, while the other thread section 17.2 connects it to the slug catcher pipe 18.
The fastening element 17.4 may have a rectangular or squared shape, allowing the slug catcher joint 17 to be securely attached to the upper end of the slug catcher joint 15 using the appropriate tool.
The slug catcher pipe 18, a tubular-shaped structural element (implying a hollow interior), features two ends, and the following components: at least one extended fluid passage opening 18.1 and two external thread sections 18.2 at both ends.
The fluid passage opening 18.1 is preferably extended in the slug catcher pipe section 18 below the slug catcher top 19. In the presented embodiment, the slug catcher pipe 18 has sixteen extended fluid passage openings 18.1.
The slug catcher top 19, a cylindrical-shaped element, featuring its two opposing ends, and the following components: the base of the slug catcher top 19.1 and the body the slug catcher top 19.2.
The base of the slug catcher top 19.1 is further constructed to include an extended opening 19.3, the internal thread section 19.4, and the cavity 19.5 into which the slug catcher pipe 18 is introduced and secured by screwing it onto the thread section 19.4. The base of the slug catcher top 19.1 also includes the conical taper 19.6 at the end opposite to the end with the extended opening 19.3.
The body of the slug catcher top 19.2 is connected at its one end to the part of the base of the slug catcher top 19.1 with the conical taper 19.6, while it features the cascading extended piece 19.7 at its other end, and concludes with the conical taper of its structure 19.8, forming a truncated cone. The body of the slug catcher top 19.2 also encompasses a fastening element 19.9 extended in the form of a groove 19.9.
The fastening element 19.9 may have a rectangular or squared shape, allowing the slug catcher top 19 to be securely attached to the slug catcher pipe 18 in the described manner, by using the appropriate tool.
The cascading expansion 19.7 enables the installation and removal tool to be attached to the retrievable check valve enabling its lowering or pulling out from the tubing, when necessary.
The slug catcher top 19 can be produced either as a single-piece unit or assembled from multiple connecting parts described earlier. In the case of the latter, the joining method can involve welding.

1. Retrievable check valve comprising:
a holder,
a shear pin,
an opened ball cage casing,
an opened ball cage,
a ball,
a ball seat,
two O-rings,
a valve body,
a mech-lock,
a mech-lock holder,
a rubber seal,
a seating nipple,
wherein the holder is cylindrical and comprises: a holder body, a holder base with thread section, a holder top; wherein the holder body has two opposing ends, one end connected to one end of the holder base, and the other end connected to the other end of the holder top, the holder body further includes a fastening element in the form of a groove and at least one shear pin opening located beneath the holder top, wherein the holder base has two ends with a thread section, one end connected to one end of the holder body, and the other end introduced through the opening of the opened ball cage casing to the opened ball cage opening, wherein it is connected by screwing, wherein the holder top has two ends, one end being connected to the holder body, and the other end being a conically tapered construction,
wherein the shear pin is cylindrical, with a diameter necessarily smaller than the pin opening it is inserted into,
wherein the opened ball cage casing is cylindrical, with two opposing ends, having differing diameters throughout the structure of its casing, forming narrower and wider parts, wherein the opened ball cage casing comprises: a opened ball cage casing body, a opened ball cage casing neck, a ring-shaped element, wherein the opened ball cage casing body is constructed so as to feature its two ends, a hollow interior, with a wider opening at one end, and the other end conically tapered and forming a truncated cone, wherein the opened ball cage casing body connects to the opened ball cage casing neck, wherein the opened ball cage casing body further comprises three extended fluid passage openings extending from half the length of the opened ball cage casing body to the edge of the body where the cone begins, further the opened ball cage casing neck is
connected at one end to the opened ball cage casing body and at the other end to the ring-shaped element, including an extended opening; the ring-shaped element has a larger diameter than the diameter of the opened ball cage casing neck and forms a flattened extension, including an extended opening through which the shear pin is introduced to the shear pin opening,
wherein the opened ball cage is cylindrical, with two opposing ends, a hollow interior, and comprises a narrow opening and a wide opening, two thread sections, a conical taper, three fluid passage openings, three hard-lined guides, one thread section being threaded on the inner side near the wide opening and allows the opened ball cage to contact to the valve body, wherein the other thread section is threaded on the inner side near the narrow opening, wherein the conical taper is extended at the narrow opening, wherein the fluid passage openings are on the lateral sides of the opened ball cage, wherein the hard-lined guides are extended on the inner surface between adjacent fluid passage openings, constructed to reinforce the structure; wherein a gap is formed between the fluid passage openings and the fluid passage openings,
wherein the ball has a larger diameter than the diameter of the fluid passage openings of the opened ball cage, and the fluid passage openings, wherein the ball in a resting state forms the contact with the upper edge of the opening of the ball seat,
wherein the ball seat is cylindrical and comprises an opening, flattened surfaces, an inner edge of the opening, an outer edge of the opening, wherein the opening is extended in the middle of the structure and has a smaller diameter than the diameter of the ball, wherein the flattened surfaces are on the upper and lower sides of the ball seat, wherein the inner edge of the opening is inclined towards the interior of the ball seat,
wherein each O-ring is ring-shaped and fits into the groove,
wherein the valve body is cylindrical, hollow inside, and comprises the following elements two openings, a thread sections, a groove, a fluid backflow opening, a fastening element, conically chamfered edges, a cascading expansion, wherein each opening is at the opposite end of the valve body, the thread sections are threaded on the external surface of the structure, wherein the described elements are preferably arranged as follows: the opening, the thread section, the groove, the fluid drainage opening, the groove, the fastening element, the groove, conically chamfered edges, the groove, between which is the construction element of the valve body, the conical expansion, the thread section ending with the other end of the valve body wherein the second opening is extended,
wherein the mech-lock is cylindrical, with two opposing ends and a hollow interior, comprising: a wider opening, a narrower opening, a flattened surface, semi-openings, a surface, conically chamfered edges, wherein the flattened surface is positioned at the narrower opening, wherein between two adjacent semi-openings, a surface is formed,
wherein the mech-lock holder is cylindrical, with two opposing ends and a hollow interior, comprising a wider opening, a narrower opening, a conical taper, a thread section, rounded edges, a groove, a conical taper on the external side, and a fastening element, wherein the conical taper is extended on the internal side to form a funnel-like structure;
wherein the thread section is threaded on the internal side of the mech-lock holder below the wider opening, wherein the rounded edges are extended at the narrower opening,
wherein the seating nipple, is cylindrical, with two opposing ends and a hollow interior, comprising: two openings, two constrictions of the internal part of the construction, two thread sections, a conical surface, a conical surface, a conical surface, a mech-lock compartment; wherein one opening is extended at opposite ends of the seating nipple beneath each opening, one thread section is extended on the external side of the seating nipple, wherein the conical surface forms a metal seal with conically chamfered edges for metal sealing, wherein the conical surface with conically chamfered edges forms a contact and holds the retrievable check valve in its seating nipple.

2. The valve of claim 1, wherein it further comprises a slug catcher, the slug catcher further comprises the following elements:
a lower part of the slug catcher joint,
an upper part of the slug catcher joint,
a rubber seal,
a slug catcher joint,
a slug catcher pipe,
a slug catcher top,
wherein the lower part of the slug catcher joint is cylindrical, with two opposing ends comprising: one opening extended on both of its opposing ends, a thread section threaded on the internal side of the construction, a thread section threaded on the external side of the construction, a flattened surface, a groove extended on the side of the construction, and four fluid passage openings, wherein the lower part of the slug catcher joint is connected by thread section to the ball cage casing by thread section, so that the holder is introduced into the lower part of the joint, further, the lower part of the slug
catcher joint is connected by thread section to the upper part of the slug catcher joint, wherein each groove is extended towards the internal side of the construction and has two ends, one end forming a rectangular shape that
continues towards the other end and changes and rounds and thus forms a semi-circular shape, wherein each rounded position of each groove comprises a fluid passage opening,
wherein the upper part of the slug catcher joint is cylindrical, constructed to have a different diameter along the entire construction so that it forms its wider and narrower part, further it comprises at least two openings, each extending from its opposing ends, a thread section threaded on the internal side of the construction, a thread section threaded on the external side of the construction, the fastening element is extended as a groove extended on the wider part,
wherein the rubber seal is ring-shaped, positioned on the external side of the upper part of the slug catcher joint on the narrower part, wherein the rubber seal with its end edges forms a contact with the internal side of the tubing,
wherein the slug catcher joint is cylindrical, with two opposing ends and a hollow interior, comprising one opening extended on both of its ends, two internal thread sections extended on both of its opposing ends, a fastening element extended as a groove in the middle of the external side of the element and cylindrical narrowing of an internal part of the construction, wherein one thread section connects the slug catcher joint to the upper part of the slug catcher joint by means of screwing over the thread section, wherein the other thread section connects it to the slug catcher pipe by means of screwing,
wherein the slug catcher pipe is constructed to be hollow inside with two ends and comprises a fluid passage opening and two external thread sections on both its ends,
wherein the top of the slug catcher top is cylindrical, with two opposing ends comprising a base of the slug catcher top and a body of the slug catcher top, wherein the base of the slug catcher top is further constructed to comprise an extended opening, an internal thread section, and a cavity into which the slug catcher pipe is introduced and secured by screwing over the thread section; further the base of the slug catcher top comprises a conical taper at the end opposite to the end where the opening is extended; wherein the body of the slug catcher top is connected at one end to the part of the base of the slug catcher top sitting next to the conical taper, wherein at the other end it comprises a cascading expansion and ends with a conical taper of the construction so as to form a structure like the truncated cone, further the body of the slug catcher top comprises a fastening element.

3. The valve of claims 2, wherein the fastening elements, are rectangular or square.

4. The valve of claim 2, wherein the number of rubber seals is at least one.

5. The valve of claim 2, wherein the number of fluid passage openings is limited to sixteen.

6. The valve of claim 2, wherein the slug catcher top is made from one piece or multiple assembled parts connected by welding.

7. The valve of claims 2, wherein the hard-lined guide is made of a material necessarily harder than the material the opened ball cage is made of and necessarily softer than the material the ball is made of.

8. The valve of claim 7, wherein the material of the hard-lined guide is metal or a metal alloy.

9. The valve of claim 7, wherein the material of the hard-lined guide is a high-resistance plastic.

10. The valve of claim 2, wherein the ball is made of a solid material.

11. The valve of claim 2, wherein the ball seat is made of ceramic.

12. The valve of claim 2, wherein the number of fluid backflow openings is limited to six such openings.

13. The valve of claim 2, wherein the number of semi-openings is limited to six such openings, with a length range of each semi-opening from 40-70% of the total length of the mech-lock construction.

14. The valve of claim 2, wherein the curvature degree of the surface is 3 degrees.

15. The valve of claim 2, wherein each fluid passage opening extends approximately from the midpoint of the length of the opened ball cage construction and extends to the conical taper.
